(19) United States
(12) Patent Application Publication
(10) Pub. No.: US 2010/0143694 A1
(43) Pub. Date: Jun. 10, 2010

(54) PROCESS FOR THERMOFORMING ACRYLIC POLYMER EMPLOYING FOAM AS A MOLD AND ARTICLE FORMED THEREFROM

(76) Inventors: William Patrick Paplham, Getzville, NY (US); John Victor Sagrati, JR., Kennett Square, PA (US); Trevor R. King, Orchard Park, NY (US); Paul D. Doak, North Tonawanda, NY (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/331,789

(22) Filed: Dec. 10, 2008

(51) Int. Cl. B32B 5/18; B29C 51/14

(52) U.S. Cl. 428/306.6; 264/510

(57) ABSTRACT

The present invention is directed to a process of thermoforming an acrylic polymer containing sheet by heating the sheet in a mold which comprises (a) a foam which would degrade if in contact with the heated sheet and (b) a thermal barrier which is intermediate the sheet and foam to prevent the foam from degrading. In many applications, the resulting article can be used without removal of the foam. Also, the foam can serve to protect the acrylic sheet such as during long distance shipping.

### BACKGROUND OF THE INVENTION

1. Field of Invention

The present invention is directed to a process of thermoforming a sheet formed from a composition containing an acrylic polymer and to an article formed thereby.

2. Description of the Related Art

Acrylic containing compositions are well known as three-dimensional solid surface materials particularly useful in the building trades for kitchen countertops, sinks and wall coverings wherein both functionality and an attractive appearance are necessary with Corian® solid surface material from DuPont being an example. Solid surface materials have found consumer appeal for inherent qualities, such as non-porous, easy to clean surfaces available in a wide range of colors and aesthetics. Typically in the building trades the acrylic containing compositions are used as a flat sheets. However an acrylic containing composition has an ability to be thermoformed using a flat sheet as a starting material

Attempts to thermoform acrylic solid surface sheets suffer from a number of problems that limit economic and practical feasibility, primarily based on shortcomings with existing mold technology. One problem is a high cost of constructing a thermoforming mold in relation to the value of the thermoformed part. Another problem is a heavy weight of the molds particularly if the mold is to have a prolonged life.

Thermoforming molds have been made from materials such as medium-density fiberboard and plywood. These materials are readily available, easily manufactured, and generally have sufficiently isotropic properties. Molds made of these materials do not immediately degrade at the temperature required to mold an acrylic sheet; however repeated exposure to thermoforming temperatures may cause delamination. Molds may also be made of a metal such as aluminum particularly when a large number of parts will be thermoformed on the same mold. Overall, mold material selection is a balance between mold longevity and initial cost to yield the lowest allocated mold cost per part.

There is a need for an economical process for thermoforming an acrylic containing sheet employing a low weight mold that will withstand the high temperatures needed to reshape the sheet.

### SUMMARY OF THE INVENTION

The present invention is directed to a process of molding a sheet containing a composition comprising an acrylic polymer having a glass transition temperature in a range from 80 to 130 degrees centigrade comprising the steps of:

(a) heating the sheet to a temperature in a range from 115 to 200 degrees centigrade; and

(b) applying a pressure differential which is elevated or under vacuum to a surface of the heated sheet to cause deformation of the sheet wherein the sheet is supported by a mold which allows deformation of the sheet wherein the mold comprises:
(i) a foam which physically degrades at a maximum temperature to which the sheet is heated; and
(ii) a thermal barrier positioned intermediate the sheet and foam wherein the thermal barrier follows surface contours of the foam with the proviso that the thermal barrier has a thermal resistance value of at least 0.05 sq-ft ° F. hour/BTU.

For use of the resulting article, the foam and thermal barrier may be removed. Alternatively the foam may be used as a shipping and cushioning material and only removed after shipping. In another embodiment the foam and thermal barrier may remain with the molded sheet and not be removed in an end use.

### DETAILED DESCRIPTION OF THE PREFERRED EMBODIMENTS

### Acrylic Containing Polymer in Sheet Form

The mold of the present invention is employed in thermoforming a sheet containing an acrylic polymer. A preferred acrylic polymer is methyl methacrylate. For purposes of illustration a sheet can be formed from a solution containing methyl methacrylate polymer dissolved in monomeric methyl methacrylate (polymer-in-monomer solution), a polymerization initiator, and inorganic filler, preferably alumina trihydrate, such as disclosed in U.S. Pat. No. 3,847,865 issued to Ray B. Duggins. The acrylic polymer has a glass transition temperature in a range from 80 to 130 degrees centigrade.

The acrylic polymer typically comprises 15 to 80%, preferably 20 to 45% by weight of the sheet and may comprise methyl methacrylate homopolymers and copolymers of methyl methacrylate with other ethylenically unsaturated compounds (e.g., vinyl acetate, styrene, alkyl acrylates, acrylonitrile, alkyl methacrylates, multifunctional acrylic monomers such as alkylene dimethacrylates and alkylene diacrylates). In addition, the sheet may contain small amounts of other polymers including polyester.

The sheet typically contains 20 to 85%, preferably about 55 to 80% by weight of an inorganic filler to aid in fire retardancy. Materials useful as fillers include titanates, barium sulfates, calcium carbonate, lithopone, china clays, magnesite, mica, iron oxides, silicone dioxide, and various siennas. A preferred filler is alumina trihydrate, disclosed in the above-referenced patent to Duggins. Optionally, the sheet material may contain decorative particles including various filled and unfilled, pigmented or dyed, insoluble or crosslinked polymers such as ABS resins, cellulose esters, cellulose ethers, epoxy resins, polyethylene, ethylene copolymers, melamine resins, phenolic resins, polyacetals, polyacrylics, polydienes, polyesters, polyisobutylenes, polypropylenes, polystyrenes, urea/formaldehyde resins, polyureas, polyurethanes, polyvinyl chloride, polyvinylidene chloride, polyvinyl esters and the like. Other useful macroscopic translucent and transparent decorative particles are natural or synthetic minerals or materials such as agate, alabaster, albite, calcite, chalcedony, chert, feldspar, flint quartz, glass, malachite, marble, mica, obsidian, opal, quartz, quartzite, rock gypsum, sand, silica, travertine, wollastonite and the like; cloth, natural and synthetic fibers; and pieces of metal.

An acrylic containing composition can be cast or molded and cured to produce a sheet structure with an important combination of properties including translucency, resistance to weather, resistance to staining by common household materials, resistance to flame, and resistance to stress cracking. In addition, a sheet can be machined by conventional techniques including sawing and sanding. This particular combination of properties makes such a structure particularly useful as kitchen or bathroom countertops, back splash panels, molded articles such as towel racks, and the like. An example of a suitable sheet thickness is in a range from one-tenth to eight-tenths inch ( 1/10″ to 8/10″).

### Foam

The foams employed as a mold in thermoforming the described acrylic compositions will degrade within a temperature range of thermoforming, namely a temperature of from 115 to 200 degrees centigrade. Such degradation, typically physical or chemical, will result in a loss of strength of the foam and/or loss of surface properties. Illustratively a surface of a foam which faces an acrylic containing composition will soften, melt and/or char. However as further described in the next section the use of a thermal barrier serves to protect a foam which would otherwise degrade at the elevated temperature and time period necessary to undertake a thermoforming process.

Examples of suitable foams are polyisocyanurate foams such as the Trymer™ foam product line available from Dow Chemical of Midland, Mich. or the Elfoam product line from the Elliot Company of Indianapolis, Ind. and polystyrene foam. An extruded polystyrene foam material may be easily shaped with means ranging from hand tools to computer controlled CNC power tools. Examples of extruded polystyrene foam include FOAMULAR® rigid foam insulation available from Owens Corning Insulating Systems, LLC of Toledo, Ohio; STYROFOAM® extruded polystyrene insulation from Dow of Midland, Mich.; and Green-Guard® available from Pactiv of Atlanta, Ga.

It is understood that the required compressive strength of a suitable foam can be readily determined dependent on the pressure employed in the thermoforming process. An increase in pressure generally requires an increase in foam compressive strength to maintain structural rigidity. Factors which influence the foam compressive strength include foam density and chemical makeup of the foam. Generally a more dense foam (assuming an identical chemical makeup) means a more rigid foam with an ability to withstand greater pressure. The decrease in compressive strength with increased temperature needs to be accounted for during foam selection.

It is understood that one or more layers of foam can be employed and the chemical makeup of the layers need not be the same. In the event the foam is to remain in place in a final article, it may be desirable to have one type of foam facing a thermal barrier and another type of foam facing in a direction opposite the thermal barrier. Generally a surface of a foam facing the thermal barrier will contact the barrier directly or through an adhesive.

The function of the foam in the thermoforming process is to act as a mold and to withstand the pressure employed in such process. The pressures employed may be above or below atmospheric since it is within the scope of thermoforming to employ vacuum conditions.

### Thermal Barrier

A thermal barrier protects a foam from the heat of an acrylic containing sheet being thermoformed. As described in the previous section the foam without the thermal barrier would otherwise, soften, melt and/or char at the employed thermoforming temperatures. As employed herein “thermal barrier” and “heat barrier” are terms which have the same meaning.

A thermal barrier is required to have a thermal resistance value of at least 0.05 sq-ft ° F. hour/BTU, and more preferably 0.5 sq-ft ° F. hour/BTU. A practical upper limit is a thermal resistance value of 10 sq-ft ° F. hour/BTU as increasing the resistance brings little additional benefit. These values are calculated according to ASTM standard C 1363-05 “Standard Test Method for Thermal Performance of Building Materials and Envelope Assemblies by Means of a Hot Box Apparatus”.

Generally, the thermal barrier will be thin since the barrier will conform to the contours of the mold under the pressure employed in thermoforming. For purposes of illustration the barrier will not be more than one or two inches in thickness although greater thickness can be employed particularly with elastomeric materials.

In most instances the thermal barrier surface will have a surface free of irregularities, i.e. a smooth or flat surface as touched by a person, since surface irregularities will be transferred to the acrylic sheet which is softened part during thermoforming. However if the surface of the acrylic sheet facing the thermal barrier is not a surface which will be generally seen in everyday use, a limitation on irregularities is less strict. However excessive irregularities on the thermal barrier can result in a degree of irregularity of an opposite surface of the acrylic sheet, i.e. the surface of the sheet which does not face the thermal barrier.

In some instances the thermal barrier may intentionally have a degree of texture for imparting the texture to the acrylic sheet during thermoforming.

Examples of materials suitable as a thermal barrier are rubbers such as ethylene-propylene-diene monomer rubber or silicone rubber, felts, paper, and fabric made with natural or synthetic materials such as aramid with an example being poly(1,3-phenylene isophtalamide).

### Creation of the Mold

The foam as described above serves as a mold and according is shaped in accordance with the desired final configuration in reshaping an acrylic sheet. A thermal barrier will follow the shape of the mold generally when the barrier is first applied to the foam. In some instances such as with use of elastomeric materials the thermal barrier will not fully conform to the shape of the mold until the application of pressure.

### Thermoforming

The conditions of thermoforming are well known in the art with use of elevated temperature which in the present process is in a range from 115 to 200 degrees centigrade in initial heating of the acrylic sheet prior to application of pressure. Illustratively the acrylic sheet may be heated in a platen or convection oven until the sheet reaches a uniform temperature.

The acrylic sheet conforms to the surface of the mold either under elevated pressure or by use of vacuum. An example of elevated pressure is in a range from five to one twenty-five psig with the understanding the optimum pressure will be dependent not only on the temperature of the sheet but also the design of the part.

Alternatively, and in many instances in a preferred mode, vacuum conditions are employed in thermoforming and a vacuum table used for forming plastics can be used. Vacuum is applied through the table and the resultant pressure differential across the vacuum membrane provides force required to conform the acrylic sheet to the mold. An example of a pressure differential for the vacuum is in a range from one to fourteen psig.

The formed acrylic sheet is cooled and may be directly used without further processing or removal of the heat barrier/foam combination. In some instances the molded acrylic sheet will be trimmed and/or sanded dependent on further use.

### Final Use

The molded acrylic sheet may be used without immediate removal or final removal of the heat barrier/foam. Illustratively the foam can act as a shipping material to protect the molded acrylic sheet during transit. Also the presence of the foam with the molded acrylic sheet may be desirable in certain building construction wherein the foam serves as a permanent installation material.

Also the molded acrylic sheet may be used with removal of only the foam allowing the heat barrier to remain in place. An example of such use is with the heat barrier formed from an elastomer serving to dampen vibrations otherwise transferred to the molded acrylic sheet.

Alternatively, the thermal barrier/foam is removed from the molded acrylic sheet.

To further illustrate the present invention, the following examples are provided.

### EXAMPLE 1

### Establishment of Maximum Unprotected Foam Temperature

Simple experiments were performed to determine suitable thermal barriers. These experiments were designed to establish a “minimal criteria” necessary for forming ¼″ solid surface at the lower end of the forming range and a “generally suitable criteria” necessary for forming ½″ solid surface at the upper end of the forming range. In each case, the solid surface was heated to a uniform temperature. It was then placed on a piece of foam covered with the tested thermal barrier. A silicone membrane was lowered over the test sample and vacuum was applied. Thermocouples on either side of the thermal barrier recorded temperatures. After the system cooled, it was evaluated for ease of removal of the thermal barrier from the foam and the solid surface as well as any damage to the foam.
Foam: Foamular® 250 extruded polystyrene
Thermal Barrier: None
Sheet: ¼″ Corian® solid surface, heated to varying temperatures.
Result No damage up to 105° C. (221° F.). At next temperature evaluated, 109° C. (228° F.) the solid surface began to stick to the foam and formed an indentation in the foam.
Foam: Elfoam® P200 polyisocyanurate foam
Thermal Barrier: None
Sheet: ¼″ Corian® solid surface, heated to varying temperatures.
Result No damage up to 137° C. (279° F.). At next temperature evaluated, 148° C. (298° F.) there was a slight indentation in the foam surface and at 158° C. (316° F.) solid surface began to stick to the foam.
Foam: Elfoam® P200 polyisocyanurate foam
Thermal Barrier: None
Sheet: ½″ Corian® solid surface, heated to varying temperatures.
Result At 123° C. (253° F.) there was only a slight indentation in the foam. At next temperature evaluated, 134° C. (273° F.) the solid surface began to stick to the foam.

Unprotected Foamular® 250 is generally unsuitable for forming ¼″ or ½″ solid surface material as it begins to soften when in direct contact with solid surface of a temperature too low for effective forming. Unprotected Elfoam® P200 polyisocyanurate foam can be used for lower temperature forming of ¼″ solid surface. For thermoforming the higher temperature ¼″ solid surface and all but extremely low temperature ½″ solid surface, the Elfoam® P200 polyisocyanurate foam is unsuitable without thermal protection.

### EXAMPLE 2

### Establishment of Minimum Protected Foam Criteria

### Elastomeric Thermal Barriers

As with unprotected foam, the suitability of a thermal barrier for the least demanding case of ¼″ solid surface at the low end of the useful thermoforming range can be determined. For these experiments, the initial foam and thermal barrier temperatures were in the range of 18-21° C. and the initial Corian® solid surface temperature was in the range of 121-123° C. Foamular® 250 extruded polystyrene foam was used for the thermoforming mold in each case.

| | | Listed | Max | Max | | | Barrier | Barrier |
|---|---|---|---|---|---|---|---|---|
| | | Max | Foam | Barrier | | | Release | release |
| | | Temp | Temp | Temp | Foam | Barrier | from | from |
| Material | Shore A | (° C.) | (° C.) | (° C.) | Damage | Damage | foam | Corian ® |
| 1/16″ Natural | 40D | 60 | 95 | 98 | none | none | ok | ok |
| Gum Rubber | | | | | | | | |
| 1/16″ Latex | 38-40D | 70 | 101 | 102 | none | none | ok | ok |
| 1/16″ SBR, Style | 75D | 77 | 100 | 101 | slightly | none | ok | ok |
| 22 Black | | | | | dulled | | | |
| 1/16″ | 60D | 82 | 96 | 97 | none | none | good | good |
| Polyurethane | | | | | | | | |
| 1/16″ Neoprene | 60D | 93 | 100 | 102 | slightly | none | good | good |
| | | | | | dulled | | | |
| 1/16″ EPDM | 60D | 107 | 100 | 103 | none | none | good | good |
| 1/16″ Butyl | 60D | 107 | 100 | 103 | slightly | none | good | good |
| rubber | | | | | dulled | | | |
| 1/16″ | 55D | 135 | 100 | 102 | none | none | good | good |
| Santoprene | | | | | | | | |
| 1/16″ Silicone | 60D | 260 | 101 | 104 | slightly | none | good | good |
| | | | | | dulled | | | |

The experiments indicate that under these conditions, many of the elastomers are suitable, even at 1/16″ thickness. The slight change in foam appearance does not indicated any issues with forming a limited number of parts, though it may indicate that better barriers could be used for extended production runs. The difficulty removing the solid surface from the thermal barrier indicates possible, but difficult in practice use as a thermal barrier.

To test for general suitability as a thermal barrier the barriers were tested with ½″ solid surface at a higher temperature. In addition to the higher initial temperature, the addition thickness means additional heat that needs to be dissipated to the environment, exposing both the thermal barrier and the underlying foam to higher temperatures for longer periods of time. For these experiments, the initial foam and thermal barrier temperatures were in the range of 18-21° C. and the initial Corian® solid surface temperature was in the range of 152-154° C. Foamular® 250 extruded polystyrene foam was used for the thermoforming mold in each case.

| | | Listed | Max | Max | | | Barrier | Barrier |
|---|---|---|---|---|---|---|---|---|
| | | Max | Foam | Barrier | | | Release | release |
| | | Temp | Temp | Temp | Foam | Barrier | from | from |
| Material | Shore A | (° C.) | (° C.) | (° C.) | Damage | Damage | foam | Corian ® |
| 1/16″ Natural | 40D | 60 | 136 | 144 | pocketed & | no | good | good |
| Gum Rubber | | | | | discolored | | | |
| 1/16″ Latex | 38-40D | 70 | 137 | 147 | pocketed & | no | good | good |
| | | | | | discolored | | | |
| 1/16″ SBR, | 75D | 77 | 138 | 145 | slight | no | tacky | good |
| Style 22 Black | | | | | | | | |
| 1/16″ | 60D | 82 | 132 | 142 | yes | no | good | good |
| Polyurethane | | | | | | | | |
| 1/16″ Neoprene | 60D | 93 | 137 | 146 | yes | no | good | good |
| 1/16″ EPDM | 60D | 107 | 138 | 145 | pocketed & | no | good | good |
| | | | | | discolored | | | |
| ¼″ EPDM | 60D | 107 | 114 | | none | none | good | good |
| 1/16″ Butyl | 60D | 107 | 148 | 142 | yes | no | good | good |
| rubber | | | | | | | | |
| 1/16″ | 55D | 135 | 141 | 148 | pocketed & | no | good | good |
| Santoprene | | | | | discolored | | | |
| 1/16″ Silicone | 60D | 260 | 101 | 104 | slightly | none | good | good |
| | | | | | dulled | | | |

The experiments at higher temperatures with ½″ solid surface indicate that at 1/16″ although many of the elastomers still released from the foam and solid surface, they did not sufficiently insulate the foam, with significant deformation occurring. Only silicone offered performance that would generally be considered suitable as the thermal barrier, as the peak temperature of the foam was much lower than the other elastomers. It can be seen by examining ¼″ EPDM that the additional thickness increased the insulation and heat absorption so that the peak foam temperature was significantly reduced versus that seen at 1/16″, making ¼″ EPDM a suitable thermal barrier. The improvement in thermal barrier performance with thicker barriers would also be expected for other elastomers.

In summary, Foamular® 250 is only suitable for direct forming with ¼″ solid surface for sheet temperatures up to 105° C. (221° F.), which is below desirable temperatures for forming, indicating that a thermal barrier is required. Elfoam® P200 polyisocyanurate foam is suitable for ¼″ solid surface forming up to sheet temperatures up to 137° C. (279° F.) and ½″ solid surface forming up to 123° C. (253° F.), above which a thermal barrier is needed. EPDM suitable for minimal thermoforming conditions at 1/16″ thickness, but ¼″ thick EPDM thermal barrier required for ½″ solid surface at higher temperatures.

### Papers and Fabrics

¼″ Solid Surface Forming With Papers and Fabrics

| | | Max | | | | Barrier |
|---|---|---|---|---|---|---|
| | Max Foam | Barrier | | | Barrier | release |
| | Temp | Temp | Foam | Barrier | Release | from |
| Material | (° C.) | (° C.) | Damage | Damage | from foam | Corian ® |
| Nomex | 94 | 119 | no | no | good | good |
| Sontara | 118 | 122 | no | no | good | good |
| 4 plies | 113 | 120 | no | no | good | good |
| Cheesecloth | | | | | | |
| ¼″ White | 82 | 115 | none | slightly | good | good |
| Polyester | | | | compressed | | |
| felt | | | | | | |
| 0.115″ Std. | 97 | 104 | pattern | none | good | good |
| Fiberglass | | | transferred | | | |
| Fabric | | | | | | |
| Aluminized | 118 | 122 | pattern | none | good | good |
| Kraft Paper | | | transferred | | | |
| Kraft paper | 112 | 120 | slight | none | good | good |
| | | | indentation | | | |

½″ Solid Surface Forming With Papers and Fabrics

| | Max | Max | | | Barrier | Barrier |
|---|---|---|---|---|---|---|
| | Foam | Barrier | | | Release | release |
| | Temp | Temp | | Barrier | from | from |
| Material | (° C.) | (° C.) | Foam Damage | Damage | foam | Corian ® |
| Nomex | 141 | 159 | imbedded Nomex | yes | bad | good |
| Sontara | 151 | 161 | severe | yes | bad | ok |
| 4 plies | 145 | 153 | some | no | tacky | good |
| Cheesecloth | | | | | | |
| ¼″ White | 129 | 154 | slight heat | compressed | difficult | good |
| Polyester | | | damage | | | |
| felt | | | | | | |
| 0.115″ Std. | 138 | 152 | fibers imbedded | none | difficult | good |
| Fiberglass | | | in foam pattern | | | |
| Fabric | | | transfer&pocketed | | | |
| Aluminized | 145 | 164 | severe damage | slightly | difficult | good |
| Kraft Paper | | | | discolored | | |

At low temperatures with ¼″ sheet, the barriers had acceptable performance. At elevated temperatures and with the higher thermal mass of ½″ sheet only the felt tested provided enough thermal protection that the foam was not severely damaged.

### Insulating Epoxy Barrier

As with unprotected foam, the suitability of a thermal barrier for the least demanding case of ¼″ solid surface at the low end of the useful thermoforming range can be determined. For these experiments, the initial foam and thermal barrier temperatures were in the range of 18-21° C. and the initial Corian® solid surface temperature was in the range of 121-123° C. Foamular® 250 extruded polystyrene foam was used for the thermoforming mold in each case.

Prior experimentation with aluminum-filled epoxy demonstrated that in that system the epoxy helped release, but did not significantly alter the thermal resistance, as aluminum is a good conductor of heat. In this experiment, hollow ceramic spheres sold as a paint additive were added to epoxy adhesive. Thirty five grams of ceramic were added to 100 grams of epoxy adhesive and spread onto extruded polystyrene foam and allowed to cure.
Foam: Foamular® 250 extruded polystyrene
Thermal Barrier: None
Sheet: ¼″ Corian® solid surface, heated to 121° C. (250° F.)
Result The maximum temperature recorded at the foam-epoxy interface with an embedded thermocouple was 85° C. (185° F.), well below the temperature at which prior experiments determined the maximum use temperature of the extruded polystyrene foam.

### SUMMARY

Foamular® 250 is only suitable for direct forming with ¼″ solid surface for sheet temperatures up to 105° C. (221° F.), which is below desirable temperatures for forming, indicating that a thermal barrier is required. Elfoam® P200 polyisocyanurate foam is suitable for ¼″ solid surface forming up to sheet temperatures up to 137° C. (279° F.) and ½″ solid surface forming up to 123° C. (253° F.), above which a thermal barrier is needed. The aluminum filled epoxy paint commonly used on MDF molds does not provide sufficient thermal protection to allow the use of extruded polystyrene foam. Using hollow ceramic spheres in an epoxy resin created a thermal barrier with good thermal insulation.

### EXAMPLE 3

### Mold Design

The design began with an electronic file provided by an architect that defined the part surface. This information combined with the thickness of the sheet to be formed and the thickness of the thermal barrier was used to design the mold surface. This surface was then segmented into several layers based on foam thickness and machining capability. In this example, Owens Corning Foamular® 250 2″ thick foam was used. Machine code was then generated from the surface design. Tooling speeds and geometries are determined by the mold material. Foam is typically cut on a CNC at 300-400 inches per minute, about the same as MDF. While the speed relatively the same as for MDF, the material removal rate is significantly higher. The spindle load for foam is much lower, allowing more material to be removed with each pass. Removal rates exceed four times that of MDF, leading to a 75% reduction in machining time. After the layers were cut on the CNC, they were assembled using hot-melt adhesive, forming the final shape.

### EXAMPLE 4

### Manual Method to Create the Solid Surface Part Blank

In this example, the solid surface part blank geometry was generated manually, though it could also be calculated digitally. The first step was to mark reference lines on the mold. A sheet of kraft paper was draped over the mold and the desired shape outline was traced onto the kraft paper. The kraft paper was removed from the mold and trimmed to the outline with scissors. The trimmed kraft paper was then positioned on the solid surface. The outline of the paper was traced onto the solid surface sheet, and the part was then cut out with a hand router.

### EXAMPLE 5

### Thermoforming Solid Surface

A part made from Corian® solid surface sheet material was heated in a platen oven until the sheet was uniformly heated at 280° F. The foam mold was placed on a vacuum table and a thermal barrier of ¼″ high-strength weather-resistant EPDM (ethylene-propylene-diene monomer) rubber was placed over the mold and aligned. The heated solid surface blank was placed on the mold, aligned, and the vacuum membrane lowered. Vacuum was applied through the table and the resultant pressure differential across the vacuum membrane provided the force required to conform the solid surface blank to the mold. The thermoformed part was left to cool and then was removed from the mold.

### EXAMPLE 6

### Use of Foam as Fixture for Post Processing

After the part was removed, the thermal barrier was removed and the foam was used to support the thermoformed part during trimming and sanding. The foam was found to dampen vibrations when used as a tooling fixture during trimming using power tools such as hand routers and CNC machines. Hot melt adhesive was used to adhere the thermoformed part to the mold temporarily to make the system more rigid for post processing. The thermoformed part was then easily removed from the mold when finished using gentle prying.

### EXAMPLE 7

### Use of Foam as a Shipping Support

The part was adhered to the foam with hot melt adhesive to secure it for shipping. The foam's low weight, uniform support, shock absorption, and vibration damping make the foam thermoforming mold an attractive shipping form.

### EXAMPLE 8

### Use of Foam as Fixture for Installation

Finally, in this case, the foam was also an integral part of the final installation as a support structure. The Corian® solid surface part was secured to the foam using hot melt adhesive and silicone adhesive. The foam provided structural rigidity and a suitable surface for securing the part to the wall and floor.

What is claimed is:

1. A process of molding a sheet containing a composition comprising an acrylic polymer having a glass transition temperature in a range from 80 to 130 degrees centigrade comprising the steps of:
(a) heating the sheet to a temperature in a range from 115 to 200 degrees centigrade; and
(b) applying pressure which is elevated or under vacuum to a surface of the heated sheet to cause deformation of the sheet wherein the sheet is supported by a mold which allows deformation of the sheet wherein, the mold comprises:
(i) a foam which physically degrades at a maximum temperature to which the sheet is heated; and
(ii) a thermal barrier positioned intermediate the sheet and foam wherein the thermal barrier follows surface contours of the foam with the proviso that the thermal barrier has a thermal resistance value of at least 0.05 sq-ft deg F hour/BTU.

2. The process of claim 1 wherein the sheet has a thickness in a range from 1/10″ to 8/10″.

3. The process of claim 1 wherein the sheet contains aluminum trihydrate.

4. The process of claim 1 wherein the foam is polystyrene or polyisocyanurate.

5. The process of claim 1 wherein the thermal barrier has a thickness in a range from 0.004 to 2″.

6. The process of claim 1 wherein the thermal barrier has a thermal resistance value of at least 0.5 sq-ft ° F. hour/BTU.

7. The process of claim 1 wherein the thermal barrier is natural gum rubber, latex rubber, styrene butadiene rubber, polyurethane, neoprene EPDM, butyl rubber, epichlorohydrin, silicone rubber, Kraft paper, or epoxy filled with ceramic spheres.

8. An article of manufacture comprising in order:
(a) a molded sheet containing a composition comprising an acrylic polymer having a glass transition temperature in a range from 80 to 130 degrees centigrade;
(b) a thermal barrier which(i) follows surface contours of (a) and (c), (ii) has a thermal resistance value of at least 0.05 sq-ft deg F hour/BTU; and
(c) foam which degrades at a temperature in a range from 115 to 200 degrees centigrade.
